(19) United States
(12) Patent Application Publication
(10) Pub. No.: US 2025/0282913 A1
(43) Pub. Date: Sep. 11, 2025

(54) DOUBLE-NETWORK ION GEL OF POLYURETHANE/1-METHYL-3-ALLYL IMIDAZOLE METAL SALT, AND PREPARATION METHOD AND USE THEREOF

(71) Applicant: Lanzhou Institute of Chemical Physics, CAS, Lanzhou City (CN)

(72) Inventors: Qihua WANG, Lanzhou City (CN); Pengrui CAO, Lanzhou City (CN); Yaoming ZHANG, Lanzhou City (CN); Tingmei WANG, Lanzhou City (CN); Xinrui ZHANG, Lanzhou City (CN); Jing YANG, Lanzhou City (CN)

(21) Appl. No.: 18/922,786

(22) Filed: Oct. 22, 2024

(30) Foreign Application Priority Data
Mar. 6, 2024 (CN) 202410251703.5

(51) Int. Cl. C08G 71/04; C08J 3/24; C08J 9/28; C10M 107/54

(52) U.S. Cl. CPC C08G 71/04; C08J 3/24; C08J 9/28; C10M 107/54

(57) ABSTRACT

A double-network (DN) ion gel of a polyurethane (PU)/1-methyl-3-allyl imidazole metal salt, and a preparation method and use thereof are provided. An ionic liquid with double bonds is modified using an inorganic metal salt, such that an anion of the ionic liquid is reacted with a metal of the inorganic metal salt to form a chelated metal ion to obtain a modified ionic liquid. The modified ionic liquid, a monomer, a cross-linking agent, a photoinitiator, an organic solvent, and a PU solution are used as raw materials, and subjected to photocuring and drying to obtain a DN ion gel, which not only shows excellent mechanical properties, but also exhibits desirable lubrication properties under dry friction conditions.

### CROSS REFERENCE TO RELATED APPLICATION

This patent application claims the benefit and priority of Chinese Patent Application No. 202410251703.5 filed with the China National Intellectual Property Administration on Mar. 6, 2024, the disclosure of which is incorporated by reference herein in its entirety as part of the present application.

### TECHNICAL FIELD

The present disclosure relates to the technical field of ion gels, and in particular to a double-network (DN) ion gel of a polyurethane (PU)/1-methyl-3-allyl imidazole metal salt, and a preparation method and use thereof.

### BACKGROUND

Compared with hydrogel materials, ion gels have attracted much attention due to more stable properties and better ionic conductivity. However, the ion gels have low mechanical properties, which limit the application in real life.

At present, people have prepared a PU material-based ion gel by adding an ionic liquid into a PU solution and evaporating a solvent, referring to “T. Li, Y. Wang, S. Li, X. Liu, J. Sun, Mechanically Robust, Elastic, and Healable Ionogels for Highly Sensitive Ultra-Durable Ionic Skins. Adv. Mater. 2020, 32, 2002706”.

However, mechanical properties of such ion gel may change greatly with the change of an ionic liquid content, and leakage of the ionic liquid in a polymer matrix cannot be avoided so far.

### SUMMARY

In view of this, an object of the present disclosure is to provide a DN ion gel of a PU/1-methyl-3-allyl imidazole metal salt, and a preparation method and use thereof. In the present disclosure, the leakage of an ionic liquid can be avoided, and the DN ion gel of the PU/1-methyl-3-allyl imidazole metal salt provided by the present disclosure shows excellent mechanical properties and desirable tribological properties.

To achieve the above object, the present disclosure provides the following technical solutions:

Provided is a method for preparing a DN ion gel of a PU/1-methyl-3-allyl imidazole metal salt, including the following steps:
providing a PU solution;
subjecting a 1-methyl-3-allyl imidazole ionic liquid and an inorganic metal salt to first mixing to obtain a modified ionic liquid, where the inorganic metal salt is one or more selected from the group consisting of a zinc salt, a terbium salt, and an europium salt;
subjecting the modified ionic liquid, a monomer, a cross-linking agent, a photoinitiator, an organic solvent, and the PU solution to second mixing to obtain a photocurable polyionic liquid solution, where the monomer includes one or more selected from the group consisting of acrylic acid and acrylamide; and
subjecting the photocurable polyionic liquid solution to photocuring and drying to obtain the DN ion gel of the PU/1-methyl-3-allyl imidazole metal salt.

In some embodiments, the PU solution is prepared by a process including the following steps:
mixing an oligomer diol and a diisocyanate, and conducting polycondensation to obtain a prepolymer; and
mixing the prepolymer with an organic solvent and a small-molecule diol, and conducting chain extension to obtain the PU solution.

In some embodiments, a molar ratio of the 1-methyl-3-allyl imidazole ionic liquid to the inorganic metal salt is in a range of 0.5:1 to 6:1; and the first mixing is conducted at a temperature of 50° C. to 55° C. for 8 h to 12 h.

In some embodiments, the cross-linking agent is one or more selected from the group consisting of poly (ethylene glycol) dimethacrylate (PEGDMA), 2-(dimethylamino) ethyl methacrylate (DMAEMA), and 2-hydroxyethyl methacrylate (HEMA); and
the photoinitiator is one or more selected from the group consisting of 1-hydroxycyclohexyl phenyl ketone and azobisisobutyronitrile (AIBN).

In some embodiments, a total mass of the monomer and the modified ionic liquid is 15% to 55% of a mass of the PU solution; and
a mass of the modified ionic liquid is 10% to 15% of a mass of the monomer.

In some embodiments, a mass of the cross-linking agent is 10% to 30% of the mass of the monomer; and
a mass of the photoinitiator is 1% to 3% of the mass of the monomer.

In some embodiments, the second mixing is conducted at ambient temperature for 1 h to 5 h.

In some embodiments, the photocuring is conducted under a high-pressure mercury lamp or an ultraviolet (UV) lamp, and the UV lamp has a UV wavelength of 360 nm to 420 nm and a UV power of 50 W/cm² to 100 W/cm²; and
the photocuring is conducted for 3 min to 10 min.

Also provided is a DN ion gel of a PU/1-methyl-3-allyl imidazole metal salt prepared by the method described above.

Further provided is use of the DN ion gel of the PU/1-methyl-3-allyl imidazole metal salt as a lubricating material.

The present disclosure provides a method for preparing a DN ion gel of a PU/1-methyl-3-allyl imidazole metal salt, including the following steps: providing a PU solution; subjecting a 1-methyl-3-allylimidazole ionic liquid and an inorganic metal salt to first mixing to obtain a modified ionic liquid, where the inorganic metal salt is one or more selected from the group consisting of a zinc salt, a terbium salt, and an europium salt; subjecting the modified ionic liquid, a monomer, a cross-linking agent, a photoinitiator, an organic solvent, and the PU solution to second mixing to obtain a photocurable polyionic liquid solution, where the monomer includes acrylic acid and/or acrylamide; and subjecting the photocurable polyionic liquid solution to photocuring and drying to obtain the DN ion gel of the PU/1-methyl-3-allyl imidazole metal salt. In the present disclosure, the ionic liquid is used as a reaction monomer to be connected into a polymer network to avoid leakage of the ionic liquid. The ionic liquid with double bonds is modified using an inorganic metal salt, such that an anion of the ionic liquid is reacted with a metal of the inorganic metal salt to form a chelated metal ion to obtain a modified ionic liquid. The modified ionic liquid, the monomer, the cross-linking agent, the photoinitiator, the organic solvent, and the PU solution are used as raw materials, and subjected to photocuring and drying to construct an ion gel with a DN structure. In the DN ion gel, one network is a PU system cross-linked by hydrogen bonds, and the other network is an acrylic acid system cross-linked by covalent bonds, and the two systems do not react with each other. The addition of metal ions causes the —COOH in acrylic acid to coordinate with the metal ions, thus further improving the mechanical properties of the acrylic system, and improving the overall performance. The DN ion gel not only shows excellent mechanical properties, but also exhibits desirable lubrication properties under dry friction conditions. Compared with traditional PU materials, the DN ion gel shows a lower and more stable friction coefficient under the dry friction conditions.

Furthermore, by chelating rare earth ions with fluorescent effect, such as terbium ions and/or europium ions, into the ionic liquid, the DN ion gel shows an obvious fluorescent effect under ultraviolet (UV). After friction, the DN ion gel shows a more obvious tracing effect on wear marks under the UV.

### BRIEF DESCRIPTION OF THE DRAWINGS

FIG. 1 shows a comparison of the mechanical properties of a DN ion gel synthesized by Zn²⁺ ion-modified ionic liquid with those of a DN elastomer synthesized by pure PU material and unmodified ionic liquid;

FIG. 2 shows mechanical properties of a DN ion gel synthesized by Tb³⁺ ion-modified ionic liquid at a molar ratio of 1:1.5;

FIG. 3 shows mechanical properties of a DN ion gel synthesized by Tb³⁺ ion-modified ionic liquid at a molar ratio of 6:1;

FIG. 4 shows mechanical properties of a DN ion gel synthesized by Eu³⁺ ion-modified ionic liquid at a molar ratio of 2:1;

FIG. 5 shows mechanical properties of a DN ion gel synthesized by Zn²⁺ ion-modified ionic liquid at a molar ratio of 2:1;

FIG. 6 shows a comparison of friction coefficients between the materials obtained in Example 3 and Comparative Example 1; and

FIG. 7 shows fluorescence characteristics of a wear mark of the material obtained in Example 3.

### DETAILED DESCRIPTION OF THE EMBODIMENTS

The present disclosure provides a method for preparing a DN ion gel of a PU/1-methyl-3-allyl imidazole metal salt, including the following steps:
providing a PU solution;
subjecting a 1-methyl-3-allylimidazole ionic liquid and an inorganic metal salt to first mixing to obtain a modified ionic liquid, where the inorganic metal salt is one or more selected from the group consisting of a zinc salt, a terbium salt, and an europium salt;
subjecting the modified ionic liquid, a monomer, a cross-linking agent, a photoinitiator, an organic solvent, and the PU solution to second mixing to obtain a photocurable polyionic liquid solution; and
subjecting the photocurable polyionic liquid solution to photocuring and drying to obtain the DN ion gel of the PU/1-methyl-3-allyl imidazole metal salt.

In the present disclosure, a PU solution is provided. In some embodiments, the PU solution is prepared by a process including the following steps:
mixing an oligomer diol and a diisocyanate, and subjecting a resulting mixture to polycondensation to obtain a prepolymer; and
mixing the prepolymer with an organic solvent and a small-molecule diol, and subjecting a resulting mixed solution to chain extension to obtain the PU solution.

In the present disclosure, in some embodiments, an oligomer diol and a diisocyanate are mixed, and a resulting mixture is subjected to polycondensation to obtain a prepolymer. In some embodiments, the oligomer diol is one or more selected from the group consisting of polytetrahydrofuran diol, polyoxypropylene diol, polycarbonate diol, and tetrahydrofuran-oxypropylene copolymer diol. In some embodiments, the oligomer diol has a molecular weight Mn of 1,000 to 2,000.

In the present disclosure, in some embodiments, the diisocyanate is one or more selected from the group consisting of toluene diisocyanate (TDI), isophorone diisocyanate (IPDI), methylenediphenyl diisocyanate (MDI), dicyclohexylmethane diisocyanate (HMDI), and hexamethylene diisocyanate (HDI).

In the present disclosure, in some embodiments, a molar ratio of the oligomer diol to the diisocyanate is in a range of 1:3 to 1:5, and preferably 1:4.

In the present disclosure, in some embodiments, the polycondensation is conducted under N₂ protection. In some embodiments, the polycondensation is conducted at a temperature of 60° C. to 80° C., and preferably 70° C. to 80° C. In some embodiments, the polycondensation is conducted for 2 h to 3 h.

In the present disclosure, in some embodiments, the prepolymer is a-NCO-terminated PU prepolymer.

In the present disclosure, in some embodiments, the prepolymer is mixed with an organic solvent and a small-molecule diol, and a resulting mixed solution is subjected to chain extension to obtain the PU solution. In some embodiments, the organic solvent is N,N-dimethylformamide (DMF). In some embodiments, the small-molecule diol is one or more selected from the group consisting of ethylene glycol, 1,4-butanediol (BDO), 1,6-hexanediol, and 1,8-octanediol.

In the present disclosure, in some embodiments, a molar ratio of the oligomer diol to the small-molecule diol is in a range of 1:2 to 1:4, and preferably 1:3.

In the present disclosure, in some embodiments, the chain extension is conducted under N₂ protection. In some embodiments, the chain extension is conducted at a temperature of 60° C. to 80° C., and preferably 70° C. to 80° C. In some embodiments, the chain extension is conducted for 3 h to 6 h, and preferably 4 h to 5 h.

In the present disclosure, in some embodiments, after the chain extension, an organic solvent is added into a resulting reaction system to adjust a viscosity of the reaction system. In some embodiments, the organic solvent is DMF.

In the present disclosure, in some embodiments, the PU solution has a solid content of 25 wt % to 35 wt %, and preferably 30 wt %.

In the present disclosure, in some embodiments, a 1-methyl-3-allyl imidazole ionic liquid and an inorganic metal salt are subjected to first mixing to obtain a modified ionic liquid. In some embodiments, the inorganic metal salt is one or more selected from the group consisting of a zinc salt, a terbium salt, and an europium salt. In some embodiments, the inorganic metal salt is one or more selected from the group consisting of ZnCl₂, Tb(NO₃)₃·6H₂O, and Eu(NO₃)₃·6H₂O.

In the present disclosure, in some embodiments, the 1-methyl-3-allyl imidazole ionic liquid is a 1-methyl-3-allyl imidazole bromide salt. In some embodiments, a molar ratio of the 1-methyl-3-allyl imidazole ionic liquid to the inorganic metal salt is in a range of 0.5:1 to 6:1, preferably 1:1 to 5:1, and more preferably 2:1 to 4:1.

In the present disclosure, in some embodiments, the first mixing is conducted at a temperature of 50° C. to 55° C., and preferably 52° C. to 54° C. In some embodiments, the first mixing is conducted for 8 h to 12 h, and preferably 10 h.

In some embodiments, the modified ionic liquid has a chemical structure shown in Formula 1:

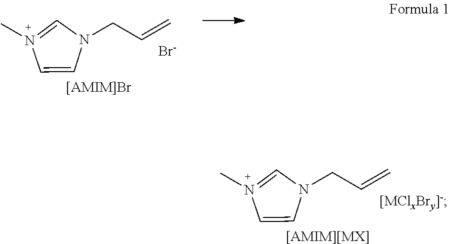

in Formula 1, M represents different metal ions; and values of x and y make [MClₓBr_{y}]⁻ have a negative monovalence.

In the present disclosure, the modified ionic liquid, a monomer, a cross-linking agent, a photoinitiator, an organic solvent, and the PU solution are subjected to second mixing to obtain a photocurable polyionic liquid solution.

In the present disclosure, in some embodiments, the monomer includes one or more selected from the group consisting of acrylic acid and acrylamide.

In the present disclosure, in some embodiments, the cross-linking agent is one or more selected from the group consisting of PEGDMA, DMAEMA, and HEMA. In some embodiments, the photoinitiator is 1-hydroxycyclohexyl phenyl ketone and/or AIBN. In some embodiments, the organic solvent is toluene and/or DMF.

In the present disclosure, in some embodiments, a total mass of the monomer and the modified ionic liquid is 15% to 55%, preferably 20% to 50%, and more preferably 30% to 40% of a mass of the PU solution.

In the present disclosure, in some embodiments, a mass of the modified ionic liquid is 10% to 15%, preferably 12% to 14% of a mass of the monomer.

In the present disclosure, in some embodiments, a mass of the cross-linking agent is 10% to 30%, and preferably 15% to 25% of the mass of the monomer.

In the present disclosure, in some embodiments, a mass of the photoinitiator is 1% to 3%, and preferably 2% of the mass of the monomer.

In the present disclosure, in some embodiments, the second mixing is conducted at a temperature of ambient temperature for 1 h to 5 h, and preferably 2 h to 4 h.

In the present disclosure, the photocurable polyionic liquid solution is subjected to photocuring and drying to obtain the DN ion gel of PU/1-methyl-3-allyl imidazole metal salt. In some embodiments, before the photocuring is conducted, the photocurable polyionic liquid solution is subjected to defoaming. In some embodiments, the photocuring is conducted in a hot mold, and the hot mold is at a temperature of 70° C. to 90° C.

In the present disclosure, in some embodiments, the photocuring is conducted under a high-pressure mercury lamp or a UV lamp.

In the present disclosure, in some embodiments, the UV lamp has a UV wavelength of 360 nm to 420 nm, and preferably 380 nm to 400 nm. In some embodiments, the UV lamp has a UV power of 50-100 W/cm², and preferably 60-80 W/cm². In the present disclosure, in some embodiments, the photocuring is conducted for 3 min to 10 min, and preferably 5 min to 8 min.

In the present disclosure, in some embodiments, the drying is conducted in a blast environment. In some embodiments, the drying is conducted at a temperature of 80° C. for 48 h to 72 h, and preferably 60 h. In the present disclosure, according to the drying, the organic solvent in the DN ion gel could be removed.

The present disclosure further provides a DN ion gel of the PU/1-methyl-3-allyl imidazole metal salt prepared by the method described above.

The present disclosure further provides use of the DN ion gel of the PU/1-methyl-3-allyl imidazole metal salt as a lubricating material. In the present disclosure, in some embodiments, the DN ion gel of the PU/1-methyl-3-allyl imidazole metal salt is used under dry friction conditions.

The DN ion gel of the PU/1-methyl-3-allyl imidazole metal salt, and the preparation method and the use thereof provided by the present disclosure will be described in detail in connection with the following examples, but they should not be construed as limiting the scope of the present disclosure.

### Example 1

70.77 g of an oligomer diol (polytetrahydrofuran diol, Mn=1,000) was placed in a 500 ml three-necked flask with mechanical stirring, and 53.08 g of MDI was added thereto. A resulting mixture was reacted at 80° C. under N₂ protection for 2 h to obtain a-NCO-terminated PU prepolymer. 150 mL of DMF was added thereto. After the prepolymer was fully dissolved, BDO (12.76 g) dissolved in 100 mL of DMF was added dropwise within 30 min. A resulting reaction system was subjected to chain extension at 80° C. under a nitrogen atmosphere for 4 h, during which 70 mL of DMF was added to maintain a solid content of 30%, thereby obtaining a PU solution.

6.7 g of zinc chloride particles as an inorganic metal salt were dissolved in 5 g of a 1-methyl-3-allyl imidazole bromide salt, and a resulting mixture was stirred in an oil bath at 50° C. for 8 h until a clear liquid was obtained, namely a modified ionic liquid in which a molar ratio of the 1-methyl-3-allyl imidazole bromide salt to the inorganic metal salt was 1:2.

6 g of the PU solution, 818.18 mg of acrylic acid, 81.85 mg of the modified ionic liquid, 245.5 mg of a cross-linking agent PEGDMA, 24.55 mg of a photoinitiator 1-hydroxycyclohexyl phenyl ketone, and 3 mL of a dehydrated DMF solvent were mixed by stirring for 2 h to obtain a photocurable DN elastomer prepolymer solution.

The photocurable DN elastomer prepolymer solution was poured into a mold and photocured under a high-pressure mercury lamp for 5 min to obtain an elastomer. The elastomer was dried in an oven at 80° C. for 48 h to remove the solvent, thereby obtaining a DN ion gel of a PU/1-methyl-3-allyl imidazole metal salt.

### Example 2

The PU solution was prepared according to the method of Example 1.

3.35 g of zinc chloride particles as an inorganic metal salt were dissolved in 5 g of a 1-methyl-3-allyl imidazole bromide salt, and a resulting mixture was stirred in an oil bath at 50° C. for 8 h until a clear liquid was obtained, namely a modified ionic liquid in which a molar ratio of the 1-methyl-3-allyl imidazole bromide salt to the inorganic metal salt was 1:1.

6 g of the PU solution, 1,909.1 mg of acrylic acid, 190.9 mg of the modified ionic liquid, 572.73 mg of a cross-linking agent PEGDMA, 57.28 mg of a photoinitiator 1-hydroxycyclohexyl phenyl ketone, and 3 mL of a dehydrated DMF solvent were mixed by stirring for 2 h to obtain a photocurable DN elastomer prepolymer solution.

The photocurable DN elastomer prepolymer solution was poured into a mold and photocured under a high-pressure mercury lamp for 5 min to obtain an elastomer. The elastomer was dried in an oven at 80° C. for 48 h to remove the solvent, thereby obtaining a DN ion gel of a PU/1-methyl-3-allyl imidazole metal salt.

### Example 3

The PU solution was prepared according to the method of Example 1.

8.92 g of Tb(NO₃) 3 6H₂O particles as an inorganic metal salt were dissolved in 2.64 g of a 1-methyl-3-allyl imidazole bromide salt, and a resulting mixture was stirred in an oil bath at 50° C. for 8 h until a clear liquid was obtained, namely a modified ionic liquid in which a molar ratio of the 1-methyl-3-allyl imidazole bromide salt to the inorganic metal salt was 1:1.5.

6 g of the PU solution, 3 g of acrylic acid, 0.3 g of the modified ionic liquid, 0.9 g of a cross-linking agent PEGDMA, 0.09 g of a photoinitiator 1-hydroxycyclohexyl phenyl ketone, and 3 mL of a dehydrated DMF solvent were mixed by stirring for 2 h to obtain a photocurable DN elastomer prepolymer solution.

The photocurable DN elastomer prepolymer solution was poured into a mold and photocured under a high-pressure mercury lamp for 5 min to obtain an elastomer. The elastomer was dried in an oven at 80° C. for 48 h to remove the solvent, thereby obtaining a DN ion gel of a PU/1-methyl-3-allyl imidazole metal salt.

### Example 4

The PU solution was prepared according to the method of Example 1.

1.86 g of Tb(NO₃) 3 6H₂O particles as an inorganic metal salt were dissolved in 5 g of a 1-methyl-3-allyl imidazole bromide salt, and a resulting mixture was stirred in an oil bath at 50° C. for 8 h until a clear liquid was obtained, namely a modified ionic liquid in which a molar ratio of the 1-methyl-3-allyl imidazole bromide salt to the inorganic metal salt was 6:1.

6 g of the PU solution, 1,909.1 mg of acrylic acid, 190.9 mg of the modified ionic liquid, 572.73 mg of a cross-linking agent PEGDMA, 57.28 mg of a photoinitiator 1-hydroxycyclohexyl phenyl ketone, and 3 mL of a dehydrated DMF solvent were mixed by stirring for 2 h to obtain a photocurable DN elastomer prepolymer solution.

The photocurable DN elastomer prepolymer solution was poured into a mold and photocured under a high-pressure mercury lamp for 5 min to obtain an elastomer. The elastomer was dried in an oven at 80° C. for 48 h to remove the solvent, thereby obtaining a DN ion gel of a PU/1-methyl-3-allyl imidazole metal salt.

### Example 5

The PU solution was prepared according to the method of Example 1.

5.49 g of Eu(NO₃) 3 6H₂O particles as an inorganic metal salt were dissolved in 5 g of a 1-methyl-3-allyl imidazole bromide salt, and a resulting mixture was stirred in an oil bath at 50° C. for 8 h until a clear liquid was obtained, namely a modified ionic liquid in which a molar ratio of the 1-methyl-3-allyl imidazole bromide salt to the inorganic metal salt was 2:1.

6 g of the PU solution, 1,909.1 mg of acrylic acid, 190.9 mg of the modified ionic liquid, 572.73 mg of a cross-linking agent PEGDMA, 57.28 mg of a photoinitiator 1-hydroxycyclohexyl phenyl ketone, and 3 mL of a dehydrated DMF solvent were mixed by stirring for 2 h to obtain a photocurable DN elastomer prepolymer solution.

The photocurable DN elastomer prepolymer solution was poured into a mold and photocured under a high-pressure mercury lamp for 5 min to obtain an elastomer. The elastomer was dried in an oven at 80° C. for 48 h to remove the solvent, thereby obtaining a DN ion gel of a PU/1-methyl-3-allyl imidazole metal salt.

### Example 6

The PU solution was prepared according to the method of Example 1.

6.7 g of zinc chloride particles as an inorganic metal salt were dissolved in 5 g of a 1-methyl-3-allyl imidazole ionic liquid, and a resulting mixture was stirred in an oil bath at 50° C. for 8 h until a clear liquid was obtained, namely a modified ionic liquid in which a molar ratio of the 1-methyl-3-allyl imidazole ionic liquid to the inorganic metal salt was 2:1.

3 g of the PU solution, 600 mg of acrylic acid, 90 mg of the modified ionic liquid, 180 mg of a cross-linking agent PEGDMA, 18 mg of a photoinitiator AIBN, and 3 mL of a dehydrated DMF solvent were mixed by stirring for 2 h to obtain a curable DN elastomer prepolymer solution.

The curable DN elastomer prepolymer solution was poured into a mold, and N₂ was introduced into a sealed container for 40 min to isolate oxygen, and then cured in an oven at 80° C. for 10 h. A resulting polymer film was further dried in a forced air oven for 48 h to remove the solvent, thereby obtaining a DN ion gel of a PU/1-methyl-3-allyl imidazole metal salt.

### Comparative Example 1

The PU solution was prepared according to the method of Example 1.

The PU solution was poured into a mold, placed in an oven at 80° C. to remove air bubbles, and dried for 48 h to remove the solvent to obtain a PU elastomer.

### Comparative Example 2

The PU solution was prepared according to the method of Example 1.

6 g of the PU solution, 1,909.1 mg of acrylic acid, 190.9 mg of 1-methyl-3-allyl imidazole bromide ionic liquid, 572.73 mg of a cross-linking agent PEGDMA, 57.28 mg of a photoinitiator 1-hydroxycyclohexyl phenyl ketone, and 3 mL of a dehydrated DMF solvent were mixed by stirring for 2 h to obtain a photocurable DN elastomer prepolymer solution.

The photocurable DN elastomer prepolymer solution was poured into a mold and photocured under a high-pressure mercury lamp for 5 min to obtain an elastomer. The elastomer was dried in an oven at 80° C. for 48 h to remove the solvent, thereby obtaining a DN ion gel of a PU/1-methyl-3-allyl imidazole metal salt.

### Performance Testing

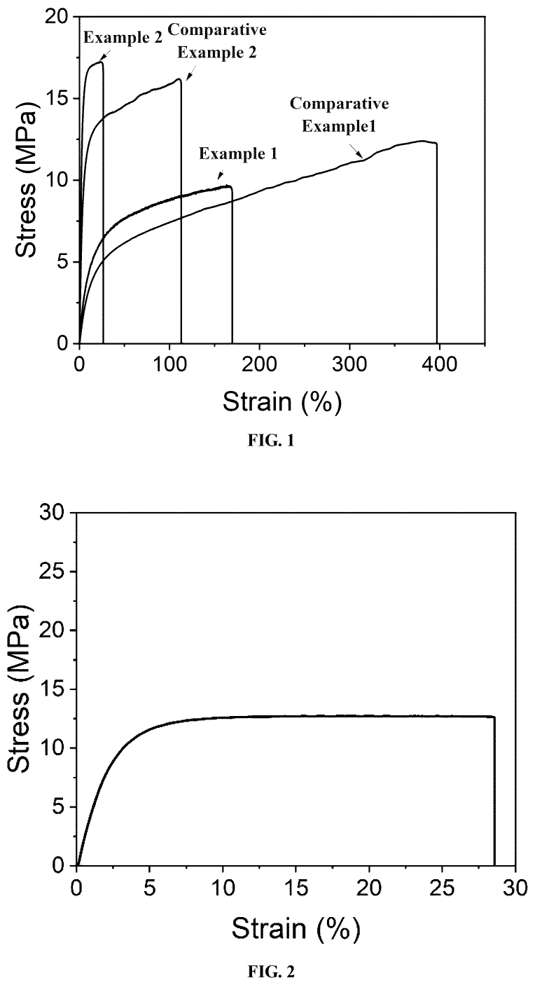

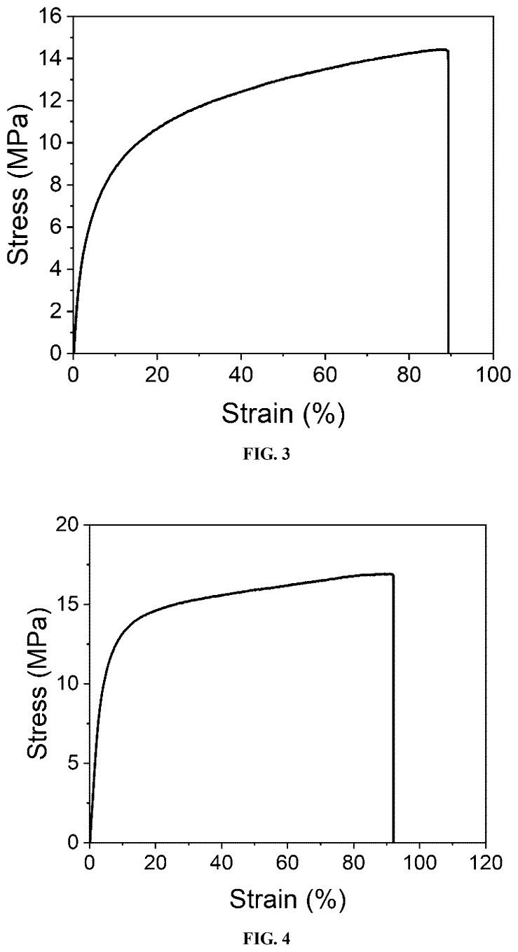

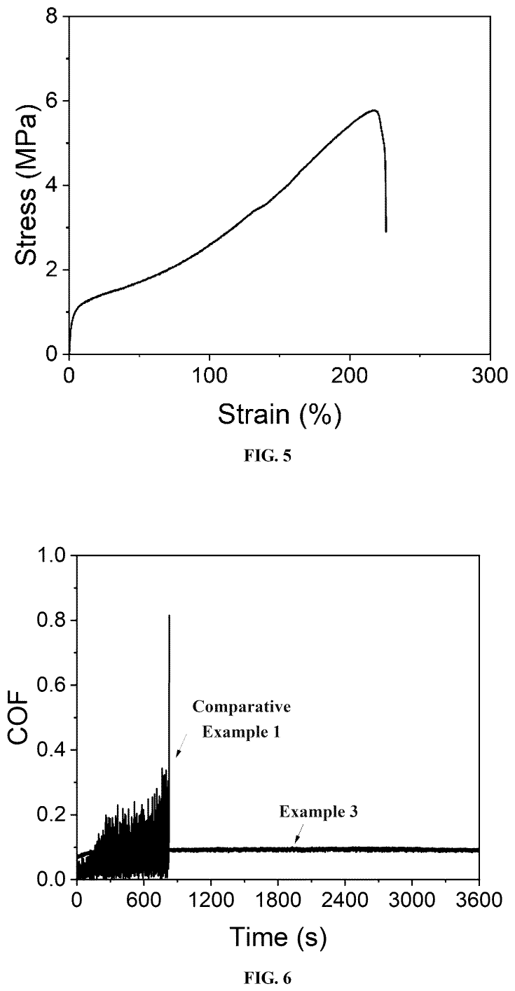

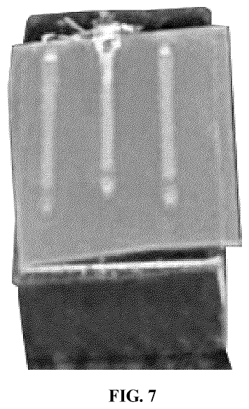

The friction properties of the materials obtained in the examples and comparative examples were tested using a CSM friction and wear tester. The mechanical properties of the materials obtained in the examples and comparative examples were tested using an electronic universal testing machine.
i) The mechanical properties of the materials obtained in Example 1, Example 2, Comparative Example 1, and Comparative Example 2 were tested at a tensile speed of 10 mm/min. The results are shown in FIG. 1. As shown in FIG. 1, the presence of zinc ions in the modified ionic liquid leads to an increased cross-linking density of the DN structure, thereby resulting in that the components using the modified ionic liquid have better mechanical properties.
ii) The mechanical properties of the DN ion gel of the PU/1-methyl-3-allyl imidazole metal salt obtained in Example 3 were tested at a tensile speed of 10 mm/min. The results are shown in FIG. 2. As shown in FIG. 2, terbium ions could undergo ion chelation with more COOH groups than zinc ions, resulting in that the DN elastomers have higher mechanical properties.
iii) The mechanical properties of the DN ion gel of the PU/1-methyl-3-allyl imidazole metal salt obtained in Example 4 were tested at a tensile speed of 10 mm/min. The results are shown in FIG. 3. As shown in FIG. 3, the mechanical properties of the DN elastomers could be effectively controlled by adjusting a relative content of terbium ions and a double bond content in the network.
iv) The mechanical properties of the DN ion gel of the PU/1-methyl-3-allyl imidazole metal salt obtained in Example 5 were tested at a tensile speed of 10 mm/min. The results are shown in FIG. 4. As shown in FIG. 4, the mechanical properties of the DN elastomer could also be adjusted by changing the cations chelated by the ionic liquid.
v) The mechanical properties of the DN ion gel of the PU/1-methyl-3-allyl imidazole metal salt obtained in Example 6 were tested at a tensile speed of 10 mm/min. The results are shown in FIG. 5. As shown in FIG. 5, the DN elastomers with excellent mechanical properties could also be prepared by changing a content of the cross-linking agent.
vi) The friction coefficient of the materials obtained in Example 3 and Comparative Example 1 under dry friction conditions was tested at a load of 2 N and a friction speed of 3 cm/s. The results are shown in FIG. 6. The wear scar fluorescence performance is shown in FIG. 7. As shown in FIG. 6 and FIG. 7, compared with pure PU material of the same component, the DN elastomer has more significant lubrication effect and wear resistance under dry friction conditions.

The above descriptions are merely preferred embodiments of the present disclosure. It should be noted that those skilled in the art may further make several improvements and modifications without departing from the principle of the present disclosure, but such improvements and modifications should be deemed as falling within the scope of the present disclosure.

What is claimed is:

1. A method for preparing a double-network (DN) ion gel of a polyurethane (PU)/1-methyl-3-allyl imidazole metal salt, comprising the following steps:
providing a PU solution;
subjecting a 1-methyl-3-allyl imidazole ionic liquid and an inorganic metal salt to first mixing to obtain a modified ionic liquid, wherein the inorganic metal salt is one or more selected from the group consisting of a zinc salt, a terbium salt, and an europium salt;
subjecting the modified ionic liquid, a monomer, a cross-linking agent, a photoinitiator, an organic solvent, and the PU solution to second mixing to obtain a photocurable polyionic liquid solution, wherein the monomer comprises one or more selected from the group consisting of acrylic acid and acrylamide; and
subjecting the photocurable polyionic liquid solution to photocuring and drying to obtain the DN ion gel of the PU/1-methyl-3-allyl imidazole metal salt.

2. The method of claim 1, wherein the PU solution is prepared by a process comprising the following steps:
mixing an oligomer diol and a diisocyanate, and conducting polycondensation to obtain a prepolymer; and
mixing the prepolymer with an organic solvent and a small-molecule diol, and conducting chain extension to obtain the PU solution.

3. The method of claim 1, wherein a molar ratio of the 1-methyl-3-allyl imidazole ionic liquid to the inorganic metal salt is in a range of 0.5:1 to 6:1; and
the first mixing is conducted at a temperature of 50° C. to 55° C. for 8 h to 12 h.

4. The method of claim 1, wherein the cross-linking agent is one or more selected from the group consisting of poly (ethylene glycol) dimethacrylate (PEGDMA), 2-(dimethylamino) ethyl methacrylate (DMAEMA), and 2-hydroxyethyl methacrylate (HEMA); and
the photoinitiator is one or more selected from the group consisting of 1-hydroxycyclohexyl phenyl ketone and azobisisobutyronitrile (AIBN).

5. The method of claim 1, wherein a total mass of the monomer and the modified ionic liquid is 15% to 55% of a mass of the PU solution; and
a mass of the modified ionic liquid is 10% to 15% of a mass of the monomer.

6. The method of claim 1, wherein a mass of the cross-linking agent is 10% to 30% of the mass of the monomer; and
a mass of the photoinitiator is 1% to 3% of the mass of the monomer.

7. The method of claim 5, wherein a mass of the cross-linking agent is 10% to 30% of the mass of the monomer; and
a mass of the photoinitiator is 1% to 3% of the mass of the monomer.

8. The method of claim 1, wherein the second mixing is conducted at ambient temperature for 1 h to 5 h.

9. The method of claim 1, wherein the photocuring is conducted under a high-pressure mercury lamp or an ultraviolet (UV) lamp, and the UV lamp has a UV wavelength of 360 nm to 420 nm and a UV power of 50 W/cm² to 100 W/cm²; and
the photocuring is conducted for 3 min to 10 min.

10. A DN ion gel of a PU/1-methyl-3-allyl imidazole metal salt prepared by the method of claim 1.

11. The DN ion gel of the PU/1-methyl-3-allyl imidazole metal salt of claim 10, wherein the PU solution is prepared by a process comprising the following steps:
mixing an oligomer diol and a diisocyanate, and conducting polycondensation to obtain a prepolymer; and
mixing the prepolymer with an organic solvent and a small-molecule diol, and conducting chain extension to obtain the PU solution.

12. The DN ion gel of the PU/1-methyl-3-allyl imidazole metal salt of claim 10, wherein a molar ratio of the 1-methyl-3-allyl imidazole ionic liquid to the inorganic metal salt is in a range of 0.5:1 to 6:1; and
the first mixing is conducted at a temperature of 50° C. to 55° C. for 8 h to 12 h.

13. The DN ion gel of the PU/1-methyl-3-allyl imidazole metal salt of claim 10, wherein the cross-linking agent is one or more selected from the group consisting of poly (ethylene glycol) dimethacrylate (PEGDMA), 2-(dimethylamino) ethyl methacrylate (DMAEMA), and 2-hydroxyethyl methacrylate (HEMA); and
the photoinitiator is one or more selected from the group consisting of 1-hydroxycyclohexyl phenyl ketone and azobisisobutyronitrile (AIBN).

14. The DN ion gel of the PU/1-methyl-3-allyl imidazole metal salt of claim 10, wherein a total mass of the monomer and the modified ionic liquid is 15% to 55% of a mass of the PU solution; and
a mass of the modified ionic liquid is 10% to 15% of a mass of the monomer.

15. The DN ion gel of the PU/1-methyl-3-allyl imidazole metal salt of claim 10, wherein a mass of the cross-linking agent is 10% to 30% of the mass of the monomer; and
a mass of the photoinitiator is 1% to 3% of the mass of the monomer.

16. The DN ion gel of the PU/1-methyl-3-allyl imidazole metal salt of claim 10, wherein the second mixing is conducted at ambient temperature for 1 h to 5 h.

17. The DN ion gel of the PU/1-methyl-3-allyl imidazole metal salt of claim 10, wherein the photocuring is conducted under a high-pressure mercury lamp or an ultraviolet (UV) lamp, and the UV lamp has a UV wavelength of 360 nm to 420 nm and a UV power of 50 W/cm² to 100 W/cm²; and
the photocuring is conducted for 3 min to 10 min.

18. A lubricating material, wherein the lubricating material is the DN ion gel of the PU/1-methyl-3-allyl imidazole metal salt of claim 10.
